(19) United States
(12) Patent Application Publication
(10) Pub. No.: US 2026/0136426 A1
(43) Pub. Date: May 14, 2026

(54) SYSTEMS AND METHODS FOR DELIVERING A MESSAGE AFTER A CONNECTION REESTABLISHMENT IN A NON-TERRESTRIAL NETWORK

(71) Applicant: Verizon Patent and Licensing Inc., Basking Ridge, NJ (US)

(72) Inventors: Chintankumar PATEL, Edison, NJ (US); Binaben Dipesh PATEL, Franklin Park, NJ (US); Andrew E. YOUTZ, Princeton, NJ (US)

(73) Assignee: Verizon Patent and Licensing Inc., Basking Ridge, NJ (US)

(21) Appl. No.: 18/947,522

(22) Filed: Nov. 14, 2024

(51) Int. Cl. H04W 76/19; H04W 4/90; H04W 76/25; H04W 84/06

(52) U.S. Cl. CPC H04W 76/19; H04W 4/90; H04W 76/25; H04W 84/06

(57) ABSTRACT

In some implementations, a network device associated with a non-terrestrial network (NTN) may establish a connection with a user equipment (UE). The network device may receive, from a server, a message. The network device may attempt to deliver the message to the UE, wherein an attempt to deliver the message is unsuccessful based on the connection being lost between the network device and the UE. The network device may transmit, to the server, an indication that the attempt to deliver the message to the UE is unsuccessful. The network device may reestablish the connection with the UE. The network device may receive, from the UE, a keep alive message. The network device may transmit, to the server, the keep alive message. The network device may receive, from the server, the message in response to the keep alive message. The network device may transmit, to the UE, the message.

### BACKGROUND

Communication systems are widely deployed to provide various telecommunication services such as telephony, video, data, messaging, and broadcasts. A network may include one or more network devices that support communication for wireless communication devices.

### BRIEF DESCRIPTION OF THE DRAWINGS

FIG. 1 is a diagram of an example associated with a non-terrestrial network (NTN).

FIG. 2 is a diagram of an example associated with delivering a message after a connection reestablishment in an NTN.

FIG. 3 is a diagram of an example associated with delivering a message after a connection reestablishment in an NTN.

FIG. 4 is a diagram of an example associated with delivering a message after a connection reestablishment in an NTN.

FIG. 5 is a diagram of an example environment in which systems and/or methods described herein may be implemented.

FIG. 6 is a diagram of example components of one or more devices of FIG. 5.

FIG. 7 is a flowchart of an example process associated with delivering a message after a connection reestablishment in an NTN.

FIG. 8 is a flowchart of an example process associated with delivering a message after a connection reestablishment in an NTN.

### DETAILED DESCRIPTION OF EXAMPLE EMBODIMENTS

The following detailed description of example implementations refers to the accompanying drawings. The same reference numbers in different drawings may identify the same or similar elements.

A user equipment (UE) may connect to an NTN, for example, when a terrestrial network is not available. In the NTN, the UE may connect to a network device (e.g., eNodeB, gNodeB, etc.) via a satellite. The network device may be relatively far away from the UE, but the satellite may allow the UE to access the network device via the satellite. On the other hand, in the terrestrial network, the UE may need to directly access the network device (e.g., no satellite), which may limit an allowed distance between the UE and the network device. In other words, in the terrestrial network, the UE may need to be close to the network device. The UE may utilize the NTN for coverage when the UE is in a remote environment without terrestrial network access.

The UE may camp on the NTN for an emergency service, such as an emergency SOS (eSOS) service, when no terrestrial network is available. The UE may need a continuous line-of-sight to the satellite for a reliable NTN communication. In other words, the UE may need to be in the satellite footprint or coverage area to ensure the reliable NTN communication. When camping on the NTN, the UE may successfully establish a connection with the NTN. When the UE loses a line-of-sight to the satellite (e.g., the UE no longer covered by the satellite for a certain duration of time), the UE may lose the connection with the NTN, such that the UE may no longer have access to the NTN. After the UE has lost access (or radio connectivity) to the NTN, any incoming mobile-terminated (MT) message/data, such as an incoming MT eSOS message, a text message, etc., may not be received by the UE. The NTN may attempt to transmit the MT eSoS message in response to a mobile-originated (MO) eSoS message that was previously transmitted by the UE when the UE was camped on the NTN for the emergency service. The NTN may attempt to deliver the MT message/data to the UE several times, but the MT message/data may not be successfully delivered to the UE when the UE has lost the connection with the NTN. In other words, as long as the UE does not have the line-of-sight to the satellite, no connection may be reestablished with the NTN and any MT message/data delivery retries may be unsuccessful. A server associated with the NTN may store the MT message/data for a certain period of time, in case the UE successfully connects back to the NTN.

In some cases, after a certain period of time, the UE may successfully reestablish the connection with the NTN. For example, the UE may reestablish the line-of-sight to the satellite (e.g., the UE may again be in the satellite coverage area), and the radio connectivity with the satellite may be reestablished. However, the server associated with the NTN may initially be unaware that the UE has successfully reestablished the connection with the NTN. Even though the server may have stored the MT message/data, the server may not be immediately notified when the UE successfully reestablishes the connection with the NTN, which may cause the UE to not receive the MT message/data or to receive the MT message/data with an increased delay, thereby degrading an overall system performance.

In one example, the server may, as a default setting, attempt three times to deliver the MT message/data to the UE, and when all three attempts are unsuccessful, the server may stop any further attempt. When all three attempts are tried without success, and then the UE successfully reestablishes the connection with the NTN, the server may no longer attempt to deliver the MT message/data to the UE. In another example, the server may, as the default setting, attempt the three times to deliver the MT message/data to the UE. An attempt may be every 5 minutes. A few seconds after a first attempt to deliver the MT message/data, which was unsuccessful, the UE may successfully reestablish the connection to the UE. However, the UE may need to wait almost 5 minutes until a second attempt is made by the server, which may result in increased latency. As a result, interruptions in connectivity with the NTN may cause pending MT messages/data to not be delivered altogether or delivered with increased latency, which may degrade the overall system performance.

In some implementations, a UE may initially be connected to a network device associated with an NTN. After a certain period of time, the UE may lose a connection with the network device. The UE may lose the connection due to a radio link failure (RLF), which may occur when the UE is not in a line-of-sight with a satellite associated with the network device. When the connection is lost, a server (e.g., an application server) that has a message intended for the UE may be unable to deliver the message to the UE, so the server may store the message for later usage. After another certain period of time, the UE may be able to reestablish the connection with the network device (e.g., when the UE returns to the line-of-sight with the satellite). In order to retrieve any messages (pending messages) that may be stored at the server, the UE may transmit a keep alive message to the server via the network device. The keep alive message may indicate to the server that the UE is now available to receive any stored messages that were previously attempted to be delivered but were unsuccessful. The UE may transmit the keep alive message as long as certain criteria are satisfied. For example, the UE may be able to transmit the keep alive message when the UE has not initiated any MO traffic for a period of time (e.g., X seconds, where X is a positive integer), and/or when the UE has not sent any keep alive message for a period of time (e.g., a last Y seconds, where Y is a positive integer). Based on the keep alive message, the server may transmit the stored message to the UE via the network device.

In some implementations, by configuring the server to store the message whose delivery was unsuccessful and by configuring the UE to transmit the keep alive message immediately after reestablishing the connection with the network device, the server may become aware when the UE is available to receive the message and the server may transmit the message to the UE. In one example, the server may attempt to deliver the message a certain number of times, but after a certain number of unsuccessful attempts, the server may stop attempting to deliver the message. By receiving the keep alive message, the server may become aware that the UE is now available to receive the message. As a result, the server may be able to transmit the message to the UE, which may not otherwise be received without the keep alive message. In another example, the server may be in between delivery attempts, and the keep alive message from the UE may allow the server to immediately send the message to the UE, rather than waiting until a subsequent delivery attempt. As a result, the server may be able to deliver the message to the UE with reduced latency. As a result, in the NTN, even with interruptions in connectivity between the UE and the network device, messages may be successfully delivered and/or delivered with decreased latency, thereby improving an overall system performance.

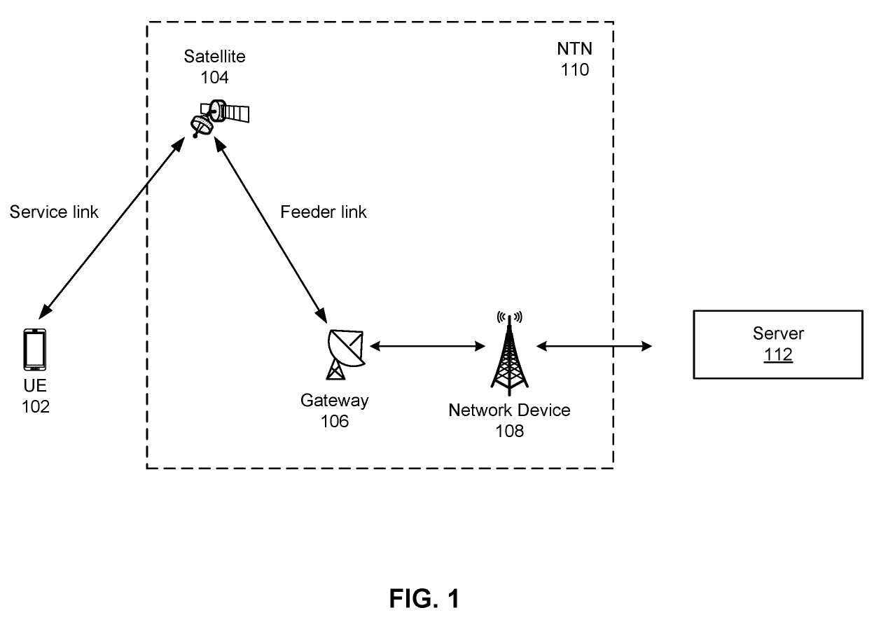

FIG. 1 is a diagram of an example 100 associated with an NTN.

As shown in FIG. 1, a UE 102 in a connected mode may communicate with a network device 108 via a satellite 104 in an NTN 110. The network device 108 may be a network node, such as a base station (e.g., gNodeB or eNodeB). The UE 102 may transmit an uplink transmission to the satellite 104. The satellite 104 may relay the uplink transmission to the network device 108 via a gateway 106. The network device 108 may transmit a downlink transmission to the satellite 104 via the gateway 106. The satellite 104 may relay the downlink transmission to the UE 102. The satellite 104, the gateway 106, and the network device 108 may be associated with the NTN 110. The network device 108 may communicate with other network devices such as server 112 (e.g., an application server). A link between the UE 102 and the satellite 104 may be a service link, and a link between the satellite 104 and the gateway 106 may be a feeder link.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

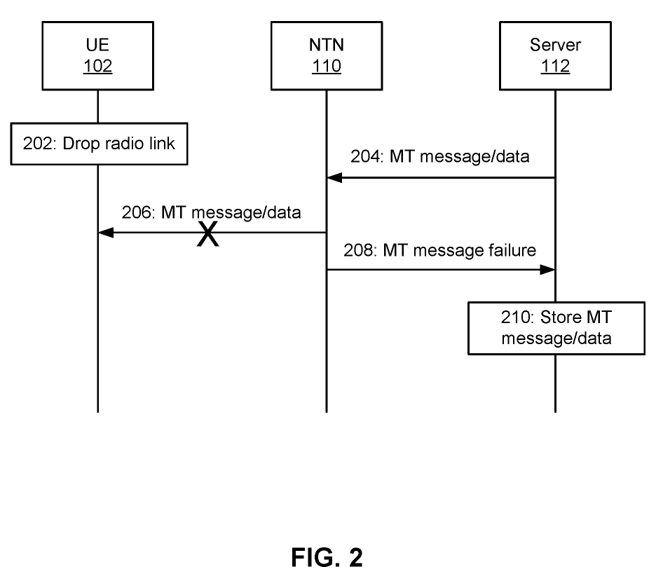

FIG. 2 is a diagram of an example 200 associated with delivering a message after a connection reestablishment in an NTN. As shown in FIG. 2, example 200 includes a UE 102, an NTN 110, and a server 112. The UE 102 may be an NTN UE. For example, the UE 102 may be configured to communicate with the NTN 110. The NTN 110 may include a satellite, a gateway, and/or a network device (as shown in FIG. 1). The server 112 may be an application server.

As shown by reference number 202, the UE 102 may drop a radio link with the NTN 110. The radio link (connection) may be dropped due to an RLF. The RLF may occur when the UE 102 loses a line-of-sight with the NTN 110. For example, when the UE 102 is no longer pointed towards a satellite associated with the NTN 110, the RLF may occur, thereby causing the UE to drop the radio link with the NTN 110. As shown by reference number 204, the server 112 may transmit an MT message/data to the NTN 110, where the MT message/data may be intended for the UE 102. The MT message/data may be an incoming MT eSOS message or another type of message. As shown by reference number 206, the NTN 110 may receive the MT message/data from the server 112, and the NTN 110 may attempt to deliver the MT message/data to the UE 102. However, since the radio link between the UE 102 and the NTN 110 has been lost, a delivery of the MT message/data may fail. In other words, a non-delivery of the MT message/data may correspond to a lost radio resource control (RRC) signal, and the delivery of the MT message/data may fail. As shown by reference number 208, the NTN 110 may determine that the delivery of the MT message/data has failed, and the NTN 110 may send an MT message/data failure indication to the server 112. Based on the MT message/data failure indication, the server 112 may be notified that the MT message/data was not successfully delivered to the UE 102. As shown by reference number 210, the server 112 may store the MT message/data for a certain duration of time in case the UE 102 reestablishes the radio link with the NTN 110.

In one example, the server 112 may attempt to redeliver the MT message/data to the UE 102 via the NTN 110. For example, the server 112 may try three attempts to deliver the MT message/data to the UE 102 via the NTN 110. After a criterion for a number of unsuccessful attempts are satisfied, the server 112 may stop trying to deliver the MT message/data to the UE 102 via the NTN 110. The server 112 may still keep the MT message/data in storage for the certain duration of time. However, if the UE 102 does successfully reestablish the radio link with the NTN 110, the server 112 may not be properly notified, in which case the MT message/data may continue to reside at the server 112 without being delivered to the UE 102. An inability for the UE 102 to successfully receive MT messages/data after reestablishing the radio link with the NTN 110 may degrade an overall system performance.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

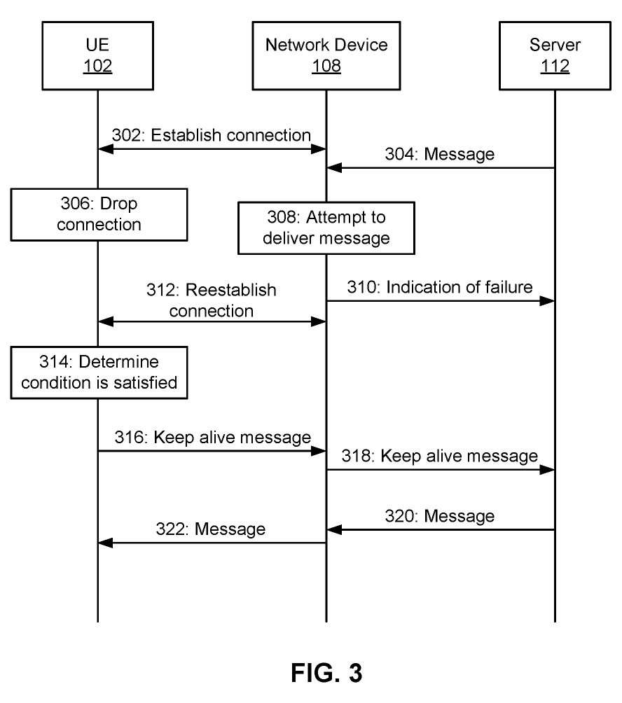

FIG. 3 is a diagram of an example 300 associated with delivering a message after a connection reestablishment in an NTN.

As shown by reference number 302, the UE 102 may establish a connection with the network device 108. The connection may be established between the UE 102 and the network device 108, (via gateway 106, not shown), based on the UE 102 being in a line-of-sight with respect to a satellite associated with the network device 108. For example, the UE 102 may connect to the network device 108 in order to access an emergency service. As shown by reference number 304, the network device 108 may receive a message from the server 112, where the message may be intended for the UE 102. The message may be an incoming MT message (or data). In one example, the message may be an emergency message, such as an eSOS message.

As shown by reference number 306, the UE 102 may drop the connection with the network device 108. The connection may be dropped due to a failure, such as an RLF. The failure may be due to the UE 102 no longer being within the line-of-sight of the satellite, which may cause the UE 102 to lose the connection with the network device 108. As shown by reference number 308, the network device 108 may attempt to deliver the message received from the server 112 to the UE 102. The attempt to deliver the message to the UE 102 may be unsuccessful based on the connection being lost between the UE 102 and the network device 108 due to the failure. As shown by reference number 310, the network device 108 may transmit, to the server 112, an indication that the attempt to deliver the message to the UE 102 is unsuccessful. The indication may serve to notify the server 112 as to whether or not the message was successfully delivered to the UE 102. When the server 112 does not receive such a notification, the server 112 may assume that the message was successfully received by the UE 102. When the server 112 receives the indication that the message was not successfully delivered to the UE 102, the server 112 may locally store the message in case the UE 102 later reestablishes the connection with the network device 108.

As shown by reference number 312, the UE 102 may reestablish the connection with the network device 108. The UE 102 may reestablish the connection based on the failure being mitigated. The connection may be reestablished between the UE 102 and the network device 108 when the UE returns to being within the line-of-sight of the satellite. As shown by reference number 314, the UE 102 may determine that a condition is satisfied. The condition may be satisfied when the UE 102, in a first state, was associated with the RLF or no service, and in a second state, has recovered from the RLF. The condition may be satisfied when the UE 102, in the first state, was associated with the non-line-of-sight with the satellite, and in the second state, is associated with the line-of-sight with the satellite. The condition may be satisfied when no UE-initiated traffic to the network device 108 has occurred for a predefined period of time after the UE 102 reestablishes the connection with the network device 108. The condition may be satisfied when no other keep alive message has been triggered in a last predefined period of time.

As shown by reference number 316, the UE 102 may transmit, to the network device 108, a keep alive message after the connection is reestablished with the network device 108. The UE may transmit the keep alive message based on the condition being satisfied. The keep alive message may be an uplink non-Internet Protocol data delivery data. The keep alive message may be to indicate that the UE 102 has reestablished the connection with the network device 108 and is now available to receive the message that was previously unsuccessful. As shown by reference number 318, the network device 108 may forward the keep alive message to the server 112. As shown by reference number 320, the server 112 may retrieve the message stored in a local memory, and then the server 112 may transmit the message to the network device 108. The server 112 may transmit the message based on a receipt of the keep alive message. In other words, the server 112 may perform a delivery reattempt, which may be triggered by the keep alive message. As shown by reference number 322, the network device 108 may forward the message to the UE 102. The UE 102 may perform one or more actions based on the message. For example, the one or more actions may be related to emergency services, for example, when the message is the eSoS message.

In some implementations, when the UE 102 reestablishes the connection (radio connectivity) with the network device 108 and meets certain conditions, the UE 102 may transmit a dummy keep alive message to the server 112. For example, the UE 102 may transmit the dummy keep alive message as part of a background process in order to wake up the server 112 (e.g., notify the server 112 that the UE 102 now has an established connection). The certain conditions may involve the first state (a previous state) and the second state (a new state). In the first state, the UE 102 was in the RLF or no service, which may be due to the UE 102 having a poor signal or not being within the satellite’s coverage area. In the second state, the UE 102 may be in the coverage area of the satellite. In the second state, the UE 102 may have recovered from the RLF or moved to a new location. For example, the UE 102 may be able to decode an NTN master information block (MIB) or system information block (SIB) with a sufficient signal-to-noise-plus-interference ratio (SINR) (e.g., an SINR that satisfies a threshold). In the second state, no UE-initiated traffic to the network device 108 may have occurred for a certain number of seconds after the UE 102 recovered from the RLF. In the second state, no keep alive message may have been triggered in a last duration of seconds/minutes. When the certain conditions are met with respect to the first state and the second state, the server 112 may retry to transmit previously undelivered messages, such that the UE 102 may be able to receive MT messages.

As indicated above, FIG. 3 is provided as an example. Other examples may differ from what is described with regard to FIG. 3. The number and arrangement of devices shown in FIG. 3 are provided as an example. In practice, there may be additional devices, fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) shown in FIG. 3 may perform one or more functions described as being performed by another set of devices shown in FIG. 3.

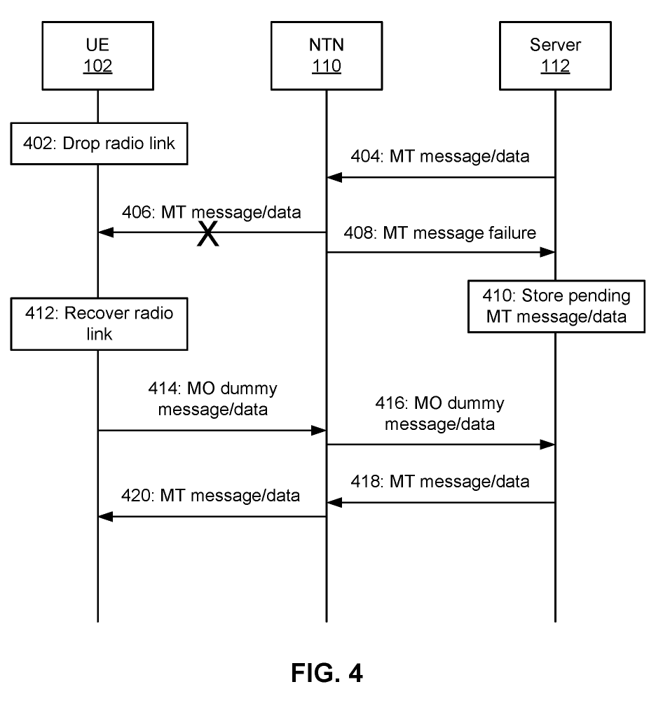

FIG. 4 is a diagram of an example 400 associated with delivering a message after a connection reestablishment in an NTN. As shown in FIG. 4, example 400 includes a UE 102, an NTN 110, and a server 112. The UE 102 may be an NTN UE. For example, the UE 102 may be configured to communicate with the NTN 110. The NTN 110 may include a satellite, a gateway, and/or a network device (as shown in FIG. 1). The server 112 may be an application server.

As shown by reference number 402, the UE 102 may drop a radio link with the NTN 110. The radio link (connection) may be dropped due to an RLF or lack of coverage. The RLF may occur when the UE 102 loses a line-of-sight with the NTN 110. For example, when the UE 102 is no longer within the satellite coverage area associated with the NTN 110, the RLF may occur, thereby causing the UE to drop the radio link with the NTN 110. As shown by reference number 404, the server 112 may transmit an MT message/data to the NTN 110, where the MT message/data may be intended for the UE 102. The MT message/data may be an incoming MT eSOS message or another type of message. As shown by reference number 406, the NTN 110 may receive the MT message/data from the server 112, and the NTN 110 may attempt to deliver the MT message/data to the UE 102. However, since the radio link between the UE 102 and the NTN 110 has been lost, a delivery of the MT message/data may fail. In other words, a non-delivery of the MT message/data may correspond to a lost RRC signal, and the delivery of the MT message/data may fail. As shown by reference number 408, the NTN 110 may determine that the delivery of the MT message/data has failed, and the NTN 110 may send an MT message/data failure indication to the server 112. Based on the MT message/data failure indication, the server 112 may be notified that the MT message/data was not successfully delivered to the UE 102. As shown by reference number 410, the server 112 may store the MT message/data for a certain duration of time in case the UE 102 reestablishes the radio link with the NTN 110.

As shown by reference number 412, the UE 102 may recover the radio link with the NTN 110. The radio link (connection) may be recovered due to the RLF being mitigated. The RLF may be mitigated when the UE 102 reestablishes the line-of-sight with the NTN 110. For example, when the UE 102 is now pointed towards the satellite associated with the NTN 110, the RLF may be mitigated, thereby causing the UE to recover the radio link with the NTN 110. As shown by reference number 414, the UE 102 may transmit an MO dummy message/data to the NTN 110. The UE 102 may transmit the MO dummy message/data when certain conditions are satisfied. For example, the UE 102 may transmit the MO dummy message/data when the UE 102 has not initiated any MO traffic for a period of time (e.g., X seconds, where X is a positive integer), and/or when the UE has not sent any MO dummy message/data for a period of time (e.g., a last Y seconds, where Y is a positive integer). The MO dummy message/data may indicate that the UE 102 has recovered the radio link with the NTN 110.

As shown by reference number 416, the NTN 110 may forward the MO dummy message/data to the server 112. The server 112, after receiving the MO dummy message/data, may retrieve the message previously stored for the UE 102 from a memory. As shown by reference number 418, the server 112 may transmit the message to the NTN 110. As shown by reference number 420, the NTN 110 may forward the message to the UE 102.

As indicated above, FIG. 4 is provided as an example. Other examples may differ from what is described with regard to FIG. 4. The number and arrangement of devices shown in FIG. 4 are provided as an example. In practice, there may be additional devices, fewer devices, different devices, or differently arranged devices than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) shown in FIG. 4 may perform one or more functions described as being performed by another set of devices shown in FIG. 4.

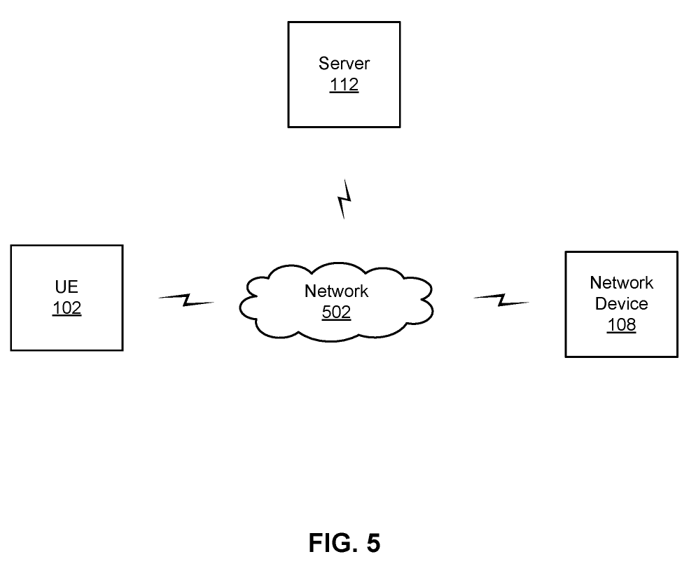

FIG. 5 is a diagram of an example environment 500 in which systems and/or methods described herein may be implemented. As shown in FIG. 5, environment 500 may include a UE 102, a network device 108, a server 112, and a network 502. Devices of environment 500 may interconnect via wired connections, wireless connections, or a combination of wired and wireless connections.

The UE 102 may include one or more devices capable of receiving, generating, storing, processing, and/or providing information associated with delivering a message after a connection reestablishment in an NTN, as described elsewhere herein. The UE 102 may include a communication device and/or a computing device. For example, the UE 102 may include a wireless communication device, a mobile phone, a laptop computer, a tablet computer, a desktop computer, a gaming console, a set-top box, a wearable communication device (e.g., a smart wristwatch, a pair of smart eyeglasses, a head mounted display, or a virtual reality headset), a smart television, an IoT device, or a similar type of device.

The network device 108 may include one or more devices capable of receiving, processing, storing, routing, and/or providing information associated with delivering a message after a connection reestablishment in an NTN, as described elsewhere herein. The network device 108 may be an aggregated network node, meaning that the aggregated network node is configured to utilize a radio protocol stack that is physically or logically integrated within a single radio access network (RAN) node (e.g., within a single device or unit). The network device 108 may be a disaggregated network node (sometimes referred to as a disaggregated base station), meaning that the network device 108 is configured to utilize a protocol stack that is physically or logically distributed among two or more nodes (such as one or more central units (CUs), one or more distributed units (DUs), or one or more radio units (RUs)). The network device 108 may include, for example, a New Radio (NR) base station, a long-term evolution (LTE) base station, a Node B, an eNB, a gNodeB, an access point, a transmission reception point (TRP), a DU, an RU, a CU, a mobility element of a network, a core network node, a network element, a network equipment, and/or a RAN node.

The server 112 may include one or more devices capable of receiving, generating, storing, processing, providing, and/or routing information associated with delivering a message after a connection reestablishment in an NTN, as described elsewhere herein. The server 112 may include a communication device and/or a computing device. For example, the server 112 may include a server, such as an application server, a client server, a web server, a database server, a host server, a proxy server, a virtual server (e.g., executing on computing hardware), or a server in a cloud computing system. In some implementations, the server 112 may include computing hardware used in a cloud computing environment.

The network 502 may include one or more wired and/or wireless networks. The network 502 may include an NTN. The network 502 may include a terrestrial network. For example, the network 502 may include a cellular network (e.g., a Fifth Generation (5G) network, a Fourth Generation (4G) network, a Long Term Evolution (LTE) network, a Third Generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 502 enables communication among the devices of environment 500.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of environment 500 may perform one or more functions described as being performed by another set of devices of environment 500.

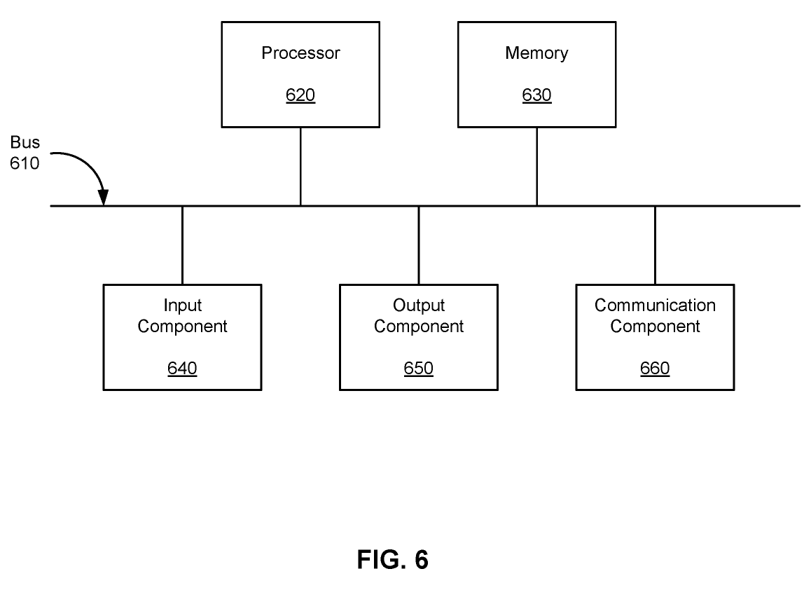

FIG. 6 is a diagram of example components of a device 600 associated with delivering a message after a connection reestablishment in an NTN. The device 600 may correspond to a device, such as a network device (e.g., network device 108) or a UE (e.g., UE 102). In some implementations, the device may include one or more devices 600 and/or one or more components of the device 600. As shown in FIG. 6, the device 600 may include a bus 610, a processor 620, a memory 630, an input component 640, an output component 650, and/or a communication component 660.

The bus 610 may include one or more components that enable wired and/or wireless communication among the components of the device 600. The bus 610 may couple together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus. The processor 620 may include a central processing unit, a graphics processing unit, a microprocessor, a controller, a microcontroller, a digital signal processor, a field-programmable gate array, an application-specific integrated circuit, and/or another type of processing component. The processor 620 may be implemented in hardware, firmware, or a combination of hardware and software. In some implementations, the processor 620 may include one or more processors capable of being programmed to perform one or more operations or processes described elsewhere herein.

The memory 630 may include volatile and/or nonvolatile memory. For example, the memory 630 may include random access memory (RAM), read only memory (ROM), a hard disk drive, and/or another type of memory (e.g., a flash memory, a magnetic memory, and/or an optical memory). The memory 630 may include internal memory (e.g., RAM, ROM, or a hard disk drive) and/or removable memory (e.g., removable via a universal serial bus connection). The memory 630 may be a non-transitory computer-readable medium. The memory 630 may store information, one or more instructions, and/or software (e.g., one or more software applications) related to the operation of the device 600. In some implementations, the memory 630 may include one or more memories that are coupled (e.g., communicatively coupled) to one or more processors (e.g., processor 620), such as via the bus 610. Communicative coupling between a processor 620 and a memory 630 may enable the processor 620 to read and/or process information stored in the memory 630 and/or to store information in the memory 630.

The input component 640 may enable the device 600 to receive input, such as user input and/or sensed input. For example, the input component 640 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 650 may enable the device 600 to provide output, such as via a display, a speaker, and/or a light-emitting diode. The communication component 660 may enable the device 600 to communicate with other devices via a wired connection and/or a wireless connection. For example, the communication component 660 may include a receiver, a transmitter, a transceiver, a modem, a network interface card, and/or an antenna.

The device 600 may perform one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. In some implementations, execution of the set of instructions, by one or more processors 620, causes the one or more processors 620 and/or the device 600 to perform one or more operations or processes described herein. In some implementations, hardwired circuitry may be used instead of or in combination with the instructions to perform one or more operations or processes described herein. Additionally, or alternatively, the processor 620 may be configured to perform one or more operations or processes described herein. Thus, implementations described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

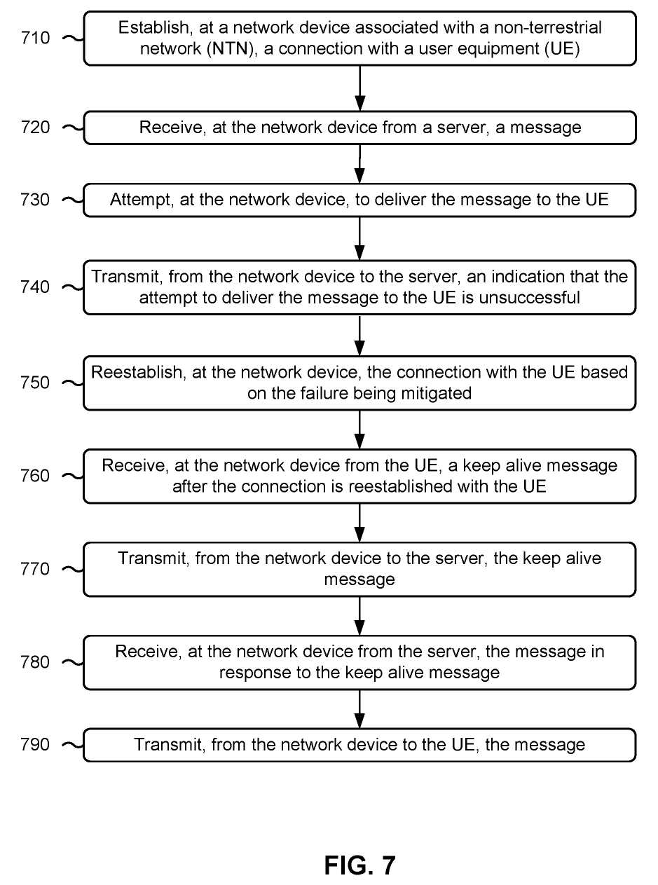

FIG. 7 is a flowchart of an example process 700 associated with delivering a message after a connection reestablishment in an NTN. In some implementations, one or more process blocks of FIG. 7 may be performed by a device, such as a network device (e.g., network device 108). In some implementations, one or more process blocks of FIG. 7 may be performed by another device or a group of devices separate from or including the device. Additionally, or alternatively, one or more process blocks of FIG. 7 may be performed by one or more components of device 600, such as processor 620, memory 630, input component 640, output component 650, and/or communication component 660.

As shown in FIG. 7, process 700 may include establishing, at the network device associated with an NTN, a connection with a UE (block 710). The connection may be established between the network device and the UE based on the UE being in a line-of-sight with respect to a satellite associated with the network device. For example, the UE may connect to the network device in order to access an emergency service.

As shown in FIG. 7, process 700 may include receiving, at the network device from a server, a message (block 720). The message may be an incoming MT message (or data), which may be intended for the UE. In one example, the message may be an emergency message, such as an eSOS message.

As shown in FIG. 7, process 700 may include attempting, at the network device, to deliver the message to the UE (block 730). An attempt to deliver the message to the UE may be unsuccessful based on the connection being lost between the network device and the UE due to a failure. For example, after the connection is established, the UE may experience the failure, such as an RLF. The failure may be due to the UE no longer being within the line-of-sight of the satellite, which may cause the UE to lose the connection with the network device.

As shown in FIG. 7, process 700 may include transmitting, from the network device to the server, an indication that the attempt to deliver the message to the UE is unsuccessful (block 740). The indication may serve to notify the server as to whether or not the message was successfully delivered to the UE. When the server does not receive such a notification, the server may assume that the message was successfully received by the UE. When the server receives the indication that the message was not successfully delivered to the UE, the server may locally store the message in case the UE later reestablishes the connection with the network device.

As shown in FIG. 7, process 700 may include reestablishing, at the network device, the connection with the UE based on the failure being mitigated (block 750). The connection may be reestablished between the network device and the UE based on the UE returning to being within the line-of-sight with respect to the satellite. In order for the connection to be reestablished with the UE, the failure may be resolved or mitigated.

As shown in FIG. 7, process 700 may include receiving, at the network device from the UE, a keep alive message after the connection is reestablished with the UE (block 760). The keep alive message may be an uplink non-Internet Protocol data delivery data. The network device may receive the keep alive message based on a condition being satisfied. The condition may be satisfied when the UE, in a first state, was associated with the RLF or no service, and in a second state, has recovered from the RLF. The condition may be satisfied when the UE, in the first state, was associated with a non-line-of-sight with the satellite, and in the second state, is associated with the line-of-sight with the satellite. The condition may be satisfied when no UE-initiated traffic to the network device has occurred for a predefined period of time after the UE reestablishes the connection with the network device. The condition may be satisfied when no other keep alive message has been triggered in a last predefined period of time.

As shown in FIG. 7, process 700 may include transmitting, from the network device to the server, the keep alive message (block 770). The network device may forward the keep alive message received from the UE to the server. The keep alive message may indicate to the server that the UE has reestablished the connection with the network device and is now available to receive the message that was previously unsuccessful.

As shown in FIG. 7, process 700 may include receiving, at the network device from the server, the message in response to the keep alive message (block 780). The network device may receive the message in accordance with a delivery reattempt, where the delivery reattempt may be triggered based on the keep alive message.

As shown in FIG. 7, process 700 may include transmitting, from the network device to the UE, the message (block 790). The network device may forward the message received from the server to the UE. The UE may perform one or more actions based on the message. For example, the one or more actions may be related to emergency services, for example, when the message is the emergency message.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

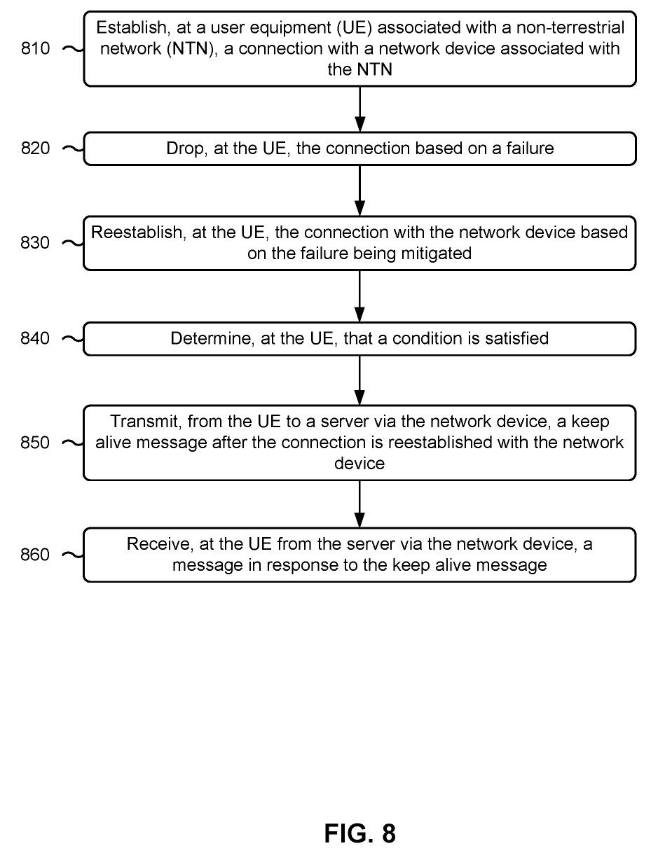

FIG. 8 is a flowchart of an example process 800 associated with delivering a message after a connection reestablishment in an NTN. In some implementations, one or more process blocks of FIG. 8 may be performed by a device, such as a UE (e.g., UE 102). In some implementations, one or more process blocks of FIG. 8 may be performed by another device or a group of devices separate from or including the device. Additionally, or alternatively, one or more process blocks of FIG. 8 may be performed by one or more components of device 600, such as processor 620, memory 630, input component 640, output component 650, and/or communication component 660.

As shown in FIG. 8, process 800 may include establishing, at the associated with an NTN, a connection with a network device associated with the NTN (block 810). The connection may be established between the UE and the network device based on the UE being in a line-of-sight with respect to a satellite associated with the network device. For example, the UE may connect to the network device in order to access an emergency service.

As shown in FIG. 8, process 800 may include dropping, at the UE, the connection based on a failure (block 820) or loss of coverage. The failure may be an RLF. The failure may be due to the UE no longer being within the line-of-sight of the satellite, which may cause the UE to lose the connection with the network device.

As shown in FIG. 8, process 800 may include reestablishing, at the UE, the connection with the network device based on the failure being mitigated (block 830). The connection may be reestablished between the UE and the network device based on the UE returning to being within the line-of-sight with respect to the satellite. In order for the connection to be reestablished with the network device, the failure may be resolved or mitigated.

As shown in FIG. 8, process 800 may include determining, at the UE, that a condition is satisfied (block 840). The condition may be satisfied when the UE, in a first state, was associated with the RLF or no service, and in a second state, has recovered from the RLF. The condition may be satisfied when the UE, in the first state, was associated with a non-line-of-sight with the satellite, and in the second state, is associated with the line-of-sight with the satellite. The condition may be satisfied when no UE-initiated traffic to the network device has occurred for a predefined period of time after the UE reestablishes the connection with the network device. The condition may be satisfied when no other keep alive message has been triggered in a last predefined period of time.

As shown in FIG. 8, process 800 may include transmitting, from the UE to a server via the network device, a keep alive message after the connection is reestablished with the network device (block 850). The UE may transmit the keep alive message based on the condition being satisfied. The keep alive message may be an uplink non-Internet Protocol data delivery data.

As shown in FIG. 8, process 800 may include receiving, at the UE from the server via the network device, a message in response to the keep alive message (block 860). The message may have been previously attempted to be delivered prior to the connection between the UE and the network device being dropped due to the failure. The server may attempt to deliver the message again to the UE based on a receipt of the keep alive message.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
establishing, a connection with a user equipment (UE) over a non-terrestrial network (NTN);
receiving, at a network device, a message;
attempting, at the network device, to deliver the message to the UE
determining, at the network device, that the attempt to deliver the message was unsuccessful;
transmitting, from the network device, an indication that the attempt to deliver the message was unsuccessful,
;
reestablishing, at the network device, the connection with the UE;
receiving, at the network device from the UE, a keep alive message after the connection is reestablished;
transmitting, from the network device , the keep alive message;
receiving, at the network device, the message in response to the keep alive message; and
transmitting, the message to the UE.

2. The method of claim 1, further comprising:
receiving the keep alive message based on a condition being satisfied.

3. The method of claim 2, wherein the condition is satisfied when the UE, in a first state, was associated with a radio link failure (RLF) or no service, and in a second state, has recovered from the RLF or no service.

4. The method of claim 2, wherein the condition is satisfied when the UE, in a first state, was associated with a non-line-of-sight with a satellite associated with the NTN, and in a second state, is associated with a line-of-sight with the satellite.

5. The method of claim 2, wherein the condition is satisfied when no UE-initiated traffic to the network device has occurred for a predefined period of time after the UE reestablishes the connection with the network device.

6. The method of claim 2, wherein the condition is satisfied when no other keep alive message has been triggered in a predefined period of time.

7. The method of claim 1, wherein the failure is a radio link failure (RLF), and wherein the RLF is based on a line-of-sight being lost between the UE and a satellite associated with the NTN.

8. The method of claim 1, wherein the failure is mitigated based on a line-of-sight being reestablished between the UE and a satellite associated with the NTN.

9. The method of claim 1, wherein the message is an emergency message.

10. The method of claim 1, wherein the keep alive message is an uplink non-Internet Protocol data delivery data.

11. The method of claim 1, further comprising:
receiving, at the network device, the message in accordance with a delivery reattempt, wherein the delivery reattempt is triggered based on the keep alive message.

12. A method, comprising:
establishing, at a user equipment (UE) associated with a non-terrestrial network (NTN), a connection with a network device associated with the NTN;
dropping, at the UE, the connection based on a failure;
reestablishing, at the UE, the connection with the network device based on the failure being mitigated;
determining, at the UE, that a condition is satisfied;
transmitting, from the UE to a server via the network device, a keep alive message after the connection is reestablished with the network device, wherein the keep alive message is transmitted based on the condition being satisfied; and
receiving, at the UE from the server via the network device, a message in response to the keep alive message, wherein the message was previously attempted to be delivered prior to the connection between the UE and the network device being dropped due to the failure.

13. The method of claim 12, wherein the condition is satisfied when the UE, in a first state, was associated with a radio link failure (RLF) or no service, and in a second state, has recovered from the RLF.

14. The method of claim 12, wherein the condition is satisfied when the UE, in a first state, was associated with a non-line-of-sight with a satellite associated with the NTN, and in a second state, is associated with a line-of-sight with the satellite.

15. The method of claim 12, wherein the condition is satisfied when no UE-initiated traffic to the network device has occurred for a predefined period of time after the UE reestablishes the connection with the network device.

16. The method of claim 12, wherein the condition is satisfied when no other keep alive message has been triggered in a last predefined period of time.

17. The method of claim 12, wherein the failure is a radio link failure (RLF), and wherein the RLF is based on a line-of-sight being lost between the UE and a satellite associated with the NTN.

18. The method of claim 12, wherein the failure is mitigated based on a line-of-sight being reestablished between the UE and a satellite associated with the NTN.

19. The method of claim 12, wherein the message is an emergency message, and wherein the keep alive message is an uplink non-Internet Protocol data delivery data.

20. A network device associated with a non-terrestrial network (NTN), comprising:
one or more processors configured to:
establish a connection with a user equipment (UE);
receive, from a server, a message;
attempt to deliver the message to the UE, wherein an attempt to deliver the message is unsuccessful based on the connection being lost between the network device and the UE due to a failure;
transmit, to the server, an indication that the attempt to deliver the message to the UE is unsuccessful, wherein the message is stored at the server;
reestablish the connection with the UE based on the failure being mitigated;
receive, from the UE, a keep alive message after the connection is reestablished with the UE;
transmit, to the server, the keep alive message;
receive, from the server, the message in response to the keep alive message; and
transmit, to the UE, the message.
